(19) United States
(12) Patent Application Publication
(10) Pub. No.: US 2023/0276294 A1
(43) Pub. Date: Aug. 31, 2023

(54) ENDPOINT IDENTIFICATION FOR QUALITY OF SERVICE

(71) Applicant: Nokia Technologies Oy, Espoo (FI)

(72) Inventors: Colin KAHN, Morris Plains, NJ (US); Devaki CHANDRAMOULI, Plano, TX (US); Peter ROST, Heidelberg (DE)

(21) Appl. No.: 18/006,579

(22) PCT Filed: Jul. 16, 2021
(86) PCT No.: PCT/IB2021/056461

§ 371 Date: Jan. 24, 2023

Related U.S. Application Data
(60) Provisional application No. 63/056,383, filed on Jul. 24, 2020.

(51) Int. Cl. H04W 28/02

(52) U.S. Cl. CPC H04W 28/0268; H04W 28/0236

(57) ABSTRACT

Systems, methods, apparatuses, and computer program products for identifying devices or endpoints connected via a 5GS, in order to provide a desired quality of service (QoS), are described.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods of identifying devices or endpoints for quality of service (QoS).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology.

5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC).

NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### BRIEF DESCRIPTION OF THE DRAWINGS:

For proper understanding of example embodiments, reference should be made to the accompanying drawings, wherein:

FIG. 1 illustrates an example system architecture in which a 5^{th} generation system (5GS) appears as a time sensitive network (TSN) bridge, according to one example;

FIG. 2 illustrates a system depicting an example method, according to an embodiment;

FIG. 3 illustrates another system depicting an example method, according to an embodiment;

FIG. 4a illustrates an example flow diagram of a method, according to an embodiment;

FIG. 4b illustrates an example flow diagram of a method, according to an embodiment;

FIG. 5a illustrates an example block diagram of an apparatus, according to an embodiment;

FIG. 5b illustrates an example block diagram of an apparatus, according to an embodiment; and

FIG. 5c illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for identifying devices or endpoints connected via a 5GS in order to provide quality of service (QoS), is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain example embodiments may relate to scenarios including time sensitive communications (TSC) and support for periodic deterministic traffic, where applications can provide requirements and/or traffic characteristics and optimization of the 5^{th} generation system (5GS) to support the traffic that is required. For example, some example embodiments may be utilized in industrial IoT (IIoT) applications where a 3GPP network provides access for devices behind a UE. However, it is noted that example embodiments may also relate to other types of networks or applications.

In industrial networks, 3^{rd} generation partnership project (3GPP) technologies may be applied in addition to fixed-line IEEE Ethernet based networks. For example, it is envisioned that wireless 5GS connectivity can be used with fixed-line IEEE Ethernet based networks in industrial environments to provide flexibility, scalability and lower total cost of ownership (TCO). Consideration is being made for adopting the option to transparently integrate the 5GS as a time sensitive network (TSN) bridge into an Ethernet network. This integration involves the 5GS appearing as an IEEE TSN bridge with full protocol compatibility between 3GPP and IEEE TSN bridged Ethernet networks. However, this may add significant complexity to the 5GS and may impose constraints on the 5GS and the data network to which it connects.

It is currently being studied how the 5GS may expose the parameters and services related to time sensitive communication (TSC) to more flexibly support various networking scenarios, including those that do not involve TSN bridges. Based on the proposed exposure framework, an application function (AF) with knowledge of the application requirements and end station connectivity via the 5GS may trigger modification of the operation of the 5GS to meet the requirements.

It is expected that enhancements to the 3GPP 5GS exposure interface will be standardized to better support industrial and/or vertical domains. An industrial automation control system or other system requiring quality of service (QoS) may then utilize the exposure interface to optimize the operation of the 5GS. For example, this is envisioned for a situation where an AF may trigger QoS and provide requirements for TSC flows in the 5GS, including, if available, information about periodic deterministic traffic characteristics, such as TSC assistance information (TSCAI) information containing stream periodicity and burst arrival times.

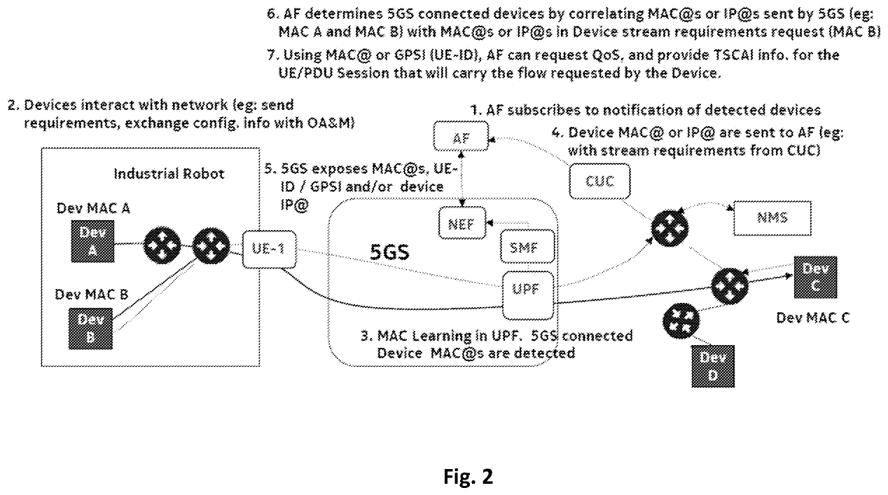

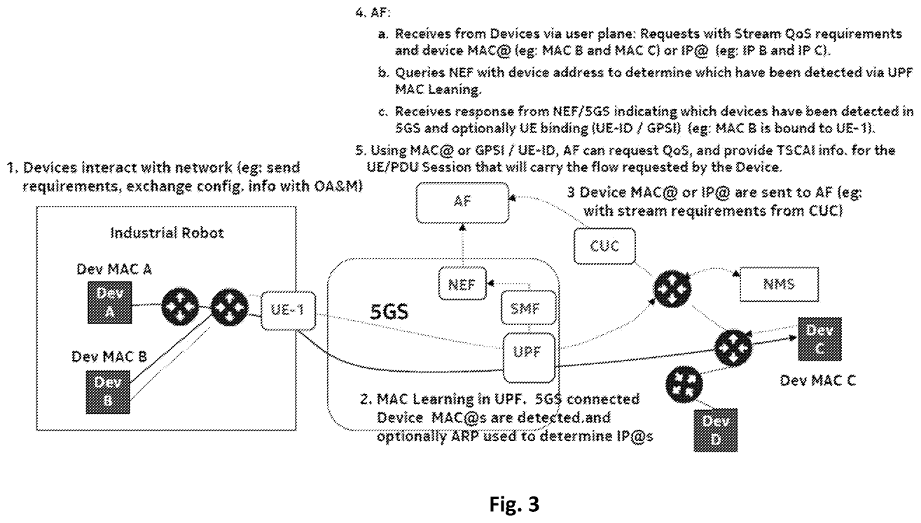

Stream requirements for devices or endpoints may be provided to an AF via the TSN fully centralized model user-to-network interface (UNI), e.g., as described in IEEE 802.1Qcc section 46. Alternatively, requirements of devices or endpoints may be communicated to the AF using open platform communication unified architecture (OPC-UA) or other protocols. When providing the requirements, devices or endpoints may be identified by an interface address such as an Ethernet medium access control (MAC) address. The devices or endpoints may be connected to bridges behind a UE. For example, in an industrial robot, several devices or endpoints may be connected to a bridge that connects to a UE, which in turn provides wireless connectivity through the 5GS to wired endpoints in an enterprise data network, as shown in FIGS. 2 and 3 discussed below. When requests are sent to the AF for these devices (e.g., using the UNI interface), neither the AF nor the endpoints are aware of the UE that provides connectivity, or even whether the endpoint is connected at all through a 5GS (it may be simply connected to a wireline bridge in the enterprise DN). Since the AF has no knowledge of whether an endpoint is connected to the 5GS, it does not know if it should request QoS from the 5GS. Example embodiments described herein can solve at least this problem, for example, by providing to the AF via the 3GPP exposure framework, the identity of wirelessly connected endpoints.

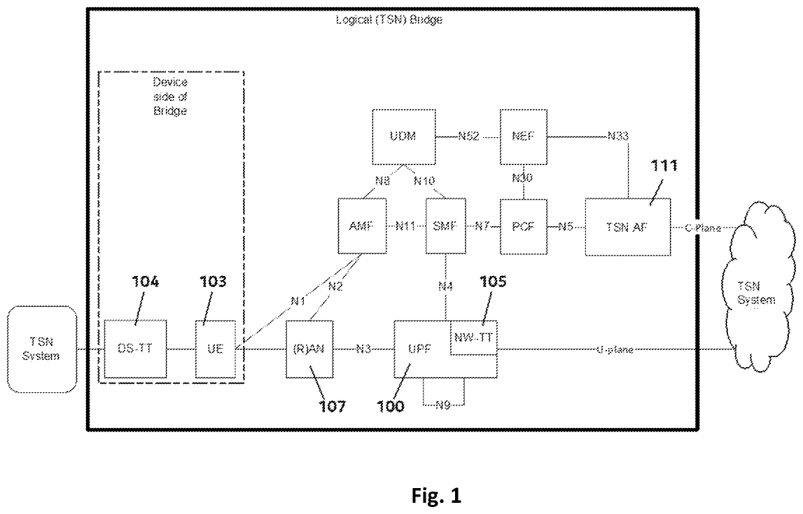

TSN is currently standardized as the mechanism for communication within industrial networks. In TSN, a set of IEEE 802.1 protocols (e.g., IEEE 802.1AS-Rev, 802.1CB, 802.1Qcc, 802.1Qch, 802.1Qci, 802.1Qcj, 802.1CM, 802.1Qcp, 802.1Qcr, 802.1AB) may be applied to achieve deterministic data transmission with guaranteed low latency with time-aware devices (which need to be configured properly). In parallel to TSN standardization, the 5GS support of TSN has been defined considering the fully centralized TSN configuration model, as illustrated in the example of FIG. 1.

More specifically, FIG. 1 illustrates an example system architecture in which a 5GS appears as a TSN bridge 101. As illustrated in the example of FIG. 1, the 5GS can be integrated transparently as a bridge into the TSN network, with a TSN Translator (TT) in the UE (DS-TT) 104 and a TSN

Translator (NW-TT) 105 in user plane function (UPF) 100. The device-side translator (DS-TT) and network-side translator (NW-TT) can perform protocol translation and adaptation. As such, the translators and the TSN-application function (AF) 111 provide interoperability between IEEE TSN network bridges (where the IEEE protocols mentioned above prevail) and the 5G core network (5GC), RAN and UE (where 3GPP protocols are applicable). In this manner, 3GPP procedures can be hidden from connected TSN networks. The TTs 104, 105 allow the 5GS bridge 101 to appear transparently as ports in the user plane, and the TSN AF 111 allows the 5GS bridge 101 to be configured as a bridge by the management plane and/or control plane, just like other TSN bridges.

Furthermore, certain 3GPP releases already support Ethernet PDU sessions. In this case, a PDU session transports Layer 2 Ethernet frames instead of Layer 3 IP packets. In the case of an

Ethernet PDU session, the UPF is able to “learn MAC addresses,” i.e., when the UPF receives on a PDU session an Ethernet frame with an unknown source-address, the UPF remembers the association of PDU session and source MAC (similar on N6 Interface). Using this “MAC Learning,” the UPF is able to build a table in which each known MAC address is associated to a PDU Session or N6 Interface. This may be used to make sure that Ethernet frames are correctly forwarded.

As will be discussed in the following, certain embodiments include a method that can provide the association between devices/endpoints and the 5GS. As such, certain embodiments may enable an AF to identify devices/endpoints and receive information about their connectivity through the 5GS, e.g., for devices/endpoints that are connected via wired bridges to a UE, as shown in FIGS. 2 and 3 discussed below. Example embodiments enable the AF to request QoS from the 5GS for device/endpoint flows as specified in endpoint requirements for connectivity services, including for TSC service.

An embodiment may provide a binding between an endpoint identified by its MAC address (MAC@), a 5GS UE-ID (eg: general public subscription identifier (GPSI)) of the UE and the N6 interface anchor point that transports flows from the endpoint. This binding may be utilized so that the AF can determine whether device/endpoint connectivity is via the 5GS, where the device/endpoint may be hidden in a network behind the UE, and/or so that the AF can send requests to the 5GS for QoS/TSC service after learning which devices are connected via a UE to the 5GS. This enables the 5GS to trigger protocol data unit (PDU) session modification to setup the requested QoS for the device for the given application.

According to certain example embodiments, device(s) or endpoint(s) may transmit data via an Ethernet PDU session established by a UE with the 5GS network. In some embodiments, devices may send stream QoS requirements to a centralized user configuration (CUC), directly communicate the QoS requirements to an AF, communicate with a management plane server, or otherwise engage in communication (which may not be related to stream requirements) with servers/devices in the network.

As outlined above, since Ethernet frames are sent by the device(s) via the 5GS, the UPF can learn the MAC addresses of the devices (frame source) and may report the MAC addresses to the SMF. Optionally, the 5GS (e.g., UPF) may use Address Resolution Protocol (ARP) or functionally similar protocol to discover the internet protocol (IP) addresses of devices served via the 5GS.

In an embodiment, stream requirements (which may be a traffic specification) from the device(s) may be received by the AF. For example, to receive the requirements, the 802.1Qcc UNI interface or a different protocol may be used. In the message containing the requirements, the requesting device(s) may be identified by their MAC address, or alternatively by an IP address. It is noted that requirements may be received for devices connected via a UE and for devices connected via the wired network.

According to one embodiment, the 5GS may provide information to the AF indicating which devices are connected via the 5GS. The 5GS may optionally provide the UE ID (GPSI) or IP address associated with a device MAC address that is learned, as discussed above. In some embodiments, the 5GS may also provide additional information associated with device connectivity via the 5GS, such as achievable delay or bandwidth for packets that require QoS.

For devices that have a MAC address, as specified with its requirements, which matches a MAC address learned by the UPF, the AF may request QoS from the 5GS. The AF may optionally use the bound UE ID/GPSI in the QoS request. The QoS request may be for TSC communication and the AF may provide input to determine TSCAI information for use by the 5GS. Alternatively, the AF may request QoS for devices whose IP address, as specified with its requirements, matches an IP address discovered by the 5GS. In formulating a request for QoS, the AF may use the various information it received from the 5GS associated with device connectivity, such as achievable delay or available bandwidth.

According to an embodiment, in order to receive information indicating which devices are connected via the 5GS, the AF may subscribe to exposure by the 5GS of learned MAC addresses (if the AF is known and trusted), IP addresses, and/or UE-IDs/GPSI. The subscription may be specific to a slice (S-NSSAI), DNN or other filter criteria. When a new MAC address is learned by the UPF/SMF, the 5GS may send a notification to the AF of the new MAC address.

According to another embodiment, to receive information indicating which devices are connected via the 5GS, the AF, after receiving requirements from a device, may query the 5GS with the MAC address of the device. The 5GS may determine whether the MAC address received from the AF has been detected via MAC learning and, if so, the 5GS may return to the AF an indication of the match, and optionally the corresponding UE ID/GPSI for the requested MAC address. Alternatively the AF may query the 5GS with an IP address of a device (or subnet of devices) and receive a response containing an indication of a matching IP address determined from a learned MAC address.

FIG. 2 illustrates an example system depicting a method for setup of QoS using MAC address correlation via a subscribe/notify procedure, according to an embodiment. More specifically, FIG. 2 illustrates an embodiment where, at 1, an AF may subscribe to exposure by the 5GS of learned MAC addresses, as introduced above. For example, in this embodiment, a network exposure function (NEF) may authorize an AF request to subscribe to notification of devices detected via MAC learning. As illustrated in the example of FIG. 2, at 2, devices (e.g., Dev A and/or Dev B connected behind UE-1, or Dev C or Dev D) may interact with the 5GS including, for example, sending their requirements. At 3, a UPF may learn or detect MAC addresses of the connected devices. For an authorized AF, at 4, the 5GS may send to the AF a notification containing a newly learned device MAC address, IP address (e.g., belonging to a device connected behind the UE) and/or GPSI/UE-ID of the UE (UE-1) and possibly a timestamp when the MAC address was seen last. In an embodiment, at 5, the 5GS may expose via a NEF the MAC addresses, IP addresses and/or GPSI/UE-ID.

When an AF receives Device requirements (e.g., from a CUC), at 6, the AF may correlate notification information received from the 5GS with IP addresses or MAC addresses received in the requests containing device requirements. For example, the requirements may be stream requirements (e.g., latency, periodicity, burst size, jitter, etc.). In certain embodiments, requests containing device requirements may originate at the devices, may be provided by a network server, or may be obtained by the AF registration of devices by the network owner. The correlation determines which devices are connected via the 5GS. In certain embodiments, at 7, the AF may then use the GPSI or device MAC address to request setup of QoS in the 5GS, and may provide the TSCAI information for the UE/PDU session that will carry the flow requested by the device. According to some embodiments, notifications may also be provided to the AF if a MAC address has not been seen by the 5GS for a time period that has been pre-configured.

FIG. 3 illustrates an example system depicting a method for setup of QoS using MAC address correlation via a query/response procedure, according to an embodiment. As illustrated in the example of FIG. 3, at 1, devices (e.g., Dev A and/or Dev B connected behind UE-1) may interact with the 5GS including, for example, sending their requirements. At 2, a UPF may learn or detect MAC addresses of the connected devices, and optionally ARP or a functionally similar protocol may be used to determine IP addresses of the devices.

In the example of FIG. 3, at 3, the AF may receive MAC addresses and/or IP addresses of the devices, along with their stream requirements. After the AF receives device requirements (e.g., stream requirements such as latency, periodicity, burst size, jitter, etc. from a CUC), or the network owner has registered the MAC address or IP address of the devices in the network, at 4, the AF may send a query containing the received device MAC address or IP address to the NEF/5GS. It is noted that this request may contain MAC addresses or IP addresses for devices that are connected via the 5GS and/or devices that have wired connections. One or more MAC addresses and/or IP addresses may be contained in each request. The 5GS may determine whether a MAC address associated with the request has been detected as a source address in UPF MAC learning. For each matching MAC address, the NEF may provide in its response to the AF an indication of the match and may optionally provide a UE-ID/GPSI of the UE associated with the learned MAC address. The 5GS may also provide additional information associated with device connectivity via the 5GS, such as achievable delay or bandwidth for packets that require QoS.

As further illustrated in the example of FIG. 3, at 5, the AF may then use the matched MAC address or the UE-ID/GPSI bound to the MAC address to trigger setup of QoS in the 5GS, and may provide the TSCAI for the UE/PDU session that will carry the flow requested by the device. In formulating a request for QoS, the AF may use the information it received from the 5GS associated with device connectivity, such as achievable delay or available bandwidth. The example of FIG. 3 may provide some security advantages since the AF would already know the MAC address or IP address of a device before the 5GS will respond with UE binding information.

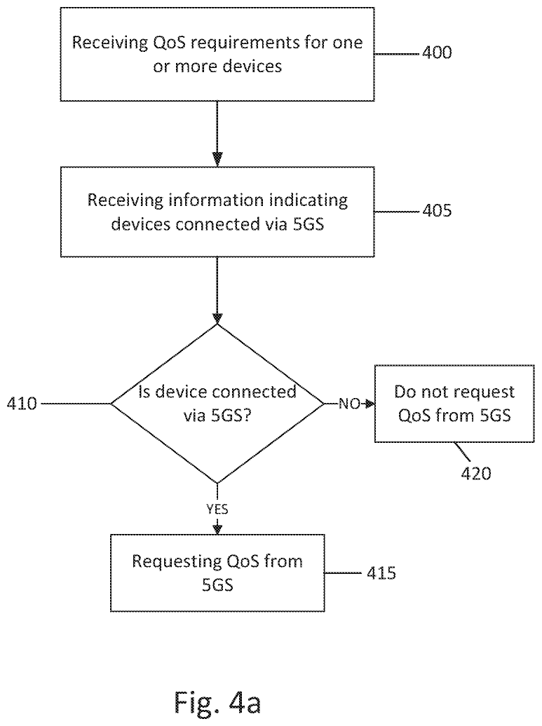

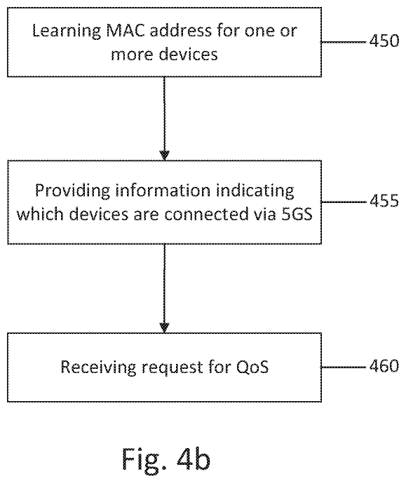

FIG. 4a illustrates an example flow diagram of a method for identifying devices or endpoints connected via a 5GS, according to one example embodiment. In certain example embodiments, the flow diagram of FIG. 4a may be performed by a network entity or network node in a 3GPP system, such as LTE or 5G NR. For instance, in some example embodiments, the method of FIG. 4a may be performed by an AF. For example, in some embodiments, the method of FIG. 4a may be performed by the AF illustrated in FIG. 2 or 3 and, therefore, the method may include any of the procedures performed by the AF of FIGS. 2 and 3, for example. The example method of FIG. 4a can enable entities, such as the AF, to request and provide desired QoS for devices connected via the 5GS.

As illustrated in the example of FIG. 4a, the method may include, at 400, receiving a message comprising QoS requirements of one or more devices. For example, the QoS requirements may be stream requirements, such as latency, periodicity, burst size, and/or jitter, etc. In an embodiment, the message may also include a MAC address and/or IP address of the one or more devices. In some embodiments, the message indicating the QoS requirements may be received from the one or more devices, from a network server (e.g., CUC), or via registration of devices by the network owner. According to certain embodiments, the one or more devices may be connected via a UE or via a wired network.

In an embodiment, the method of FIG. 4a may include, at 405, receiving, from a 5GS, information indicating which devices are connected via the 5GS. For example, the receiving 405 may include receiving MAC addresses and/or IP addresses of devices connected via the 5GS. Optionally, in an embodiment, the receiving 405 may also include receiving a UE ID (e.g., GPSI) associated with MAC addresses of devices connected via the 5GS. Further, in some embodiments, the receiving 405 may include receiving additional information associated with device connectivity via the 5GS, such as achievable delay or bandwidth for packets that require QoS.

According to some embodiments, in order to receive information indicating which devices are connected via the 5GS, the method may include subscribing to exposure by the 5GS of MAC addresses, IP addresses, and/or UE-IDs (e.g., GPSI) associated with connected devices. In this case, the receiving 405 may include, when a new MAC address is learned by the 5GS, receiving a notification of the MAC address, IP address, and/or UE-ID (e.g., GPSI) associated with the newly learned connected device. In an embodiment, the receiving 405 may also include receiving a timestamp of when the MAC address was last seen. The subscription may be specific to a slice (S-NSSAI), DNN or other filter criteria.

In certain embodiments, in order to receive information indicating which devices are connected via the 5GS, after receiving QoS requirements from a device, the method may include sending a query to the 5GS (NEF) with the MAC address or IP address of the device. In this embodiment, receiving 405 may include, when the MAC address or IP address in the query matches a MAC address or IP address of one of the devices connected via the 5GS, receiving an indication of the match, and optionally receiving the corresponding UE ID (e.g., GPSI) for the requested MAC address.

According to an embodiment, the method of FIG. 4a may include, at 410, determining whether the device(s) for which QoS requirements have been received is connected via the 5GS by correlating the MAC address or IP address received from the 5GS with the MAC address or IP address received with the QoS requirements of the device(s). When it is determined that the device(s) are connected via the 5GS, then the method may include, at 415, requesting QoS from the 5GS for the device(s). In an embodiment the requesting 415 may include using the MAC address and/or UE ID to request the QoS from the 5GS. According to an embodiment, the requesting 415 may include requesting for TSC and/or providing TSCAI for the UE/PDU session that will carry the flow requested by the device(s). Further, in some embodiments, the requesting 415 may include using the information received from the 5GS associated with device connectivity, such as achievable delay or available bandwidth, to formulate the request for QoS. When it is determined that the device(s) are not connected (i.e., there is not a match between address(es) received from the 5GS and address(es) received with the QoS requirements of the device(s)), then the method may include, at 420, not requesting QoS from the 5GS.

FIG. 4b illustrates an example flow diagram of a method for identifying devices or endpoints connected via a 5GS, according to one example embodiment. In certain example embodiments, the flow diagram of FIG. 4b may be performed by a network entity or network node in a 3GPP system, such as LTE or 5G NR. For instance, in some example embodiments, the method of FIG. 4b may be performed by one or more entities in a 5GS, such as a UPF, NEF or SMF. For example, in some embodiments, the method of FIG. 4b may be performed by entities in the 5GS illustrated in FIG. 2 or 3 and, therefore, the method may include any of the procedures performed by the UPF, NEF or SMF of FIGS. 2 and 3, for example.

According to an embodiment, the method of FIG. 4b may include, at 450, learning a MAC address of one or more device(s). For example, the learning 450 may include learning the MAC address of the device(s) based on data (e.g., PDU) transmitted by the device(s). In an embodiment, the learning 450 may also include discovering the IP address of the device(s).

According to some embodiments, the method of FIG. 4b may include, at 455, providing information, to an AF, indicating which device(s) are connected via the 5GS. For example, in an embodiment, the information provided at 455 may include information associated with device connectivity via the 5GS, such as achievable delay or bandwidth for packets that require QoS.

According to some embodiments, in order to provide the information indicating which devices are connected via the 5GS, the method may include receiving, from the AF, a request to subscribe to notification of MAC addresses learned for device(s). The AF's request to subscribe may be authorized by the 5GS (e.g., by the NEF). In this case, the providing 455 may include, when a new MAC address is learned by the 5GS, providing a notification containing the learned MAC address, IP address, and/or UE-ID (eg: GPSI) associated with the newly learned connected device. In an embodiment, the providing 455 may also include providing a timestamp of when the MAC address was last seen. In a further embodiment, the notification may be provided to the AF when the MAC address has not been seen by the 5GS for some pre-configured time period. According to an embodiment, the subscription may be specific to a slice (S-NSSAI), DNN or other filter criteria.

In another embodiment, in order to provide the information indicating which devices are connected via the 5GS, the method may include receiving a query, from the AF, with one or more MAC addresses or IP addresses of one or more devices. In this embodiment, the providing 455 may include determining whether the MAC address or IP address in the query matches a MAC address or IP address of one of the devices connected via the 5GS and, if so, transmitting an indication of the match to the AF, and optionally providing the corresponding UE ID (eg: GPSI) for the requested MAC address.

According to an embodiment, the method of FIG. 4b may include, at 460, receiving a request for QoS, from the AF, for the device(s). In an embodiment, the receiving 460 may include receiving the MAC address and/or UE ID with the request for QoS from the AF. According to an embodiment, the receiving 460 may include receiving a request for TSC and/or receiving TSCAI for the UE/PDU session that will carry the flow requested by the device(s). In one embodiment, when resources are available, the method may include providing the requested QoS for the device(s).

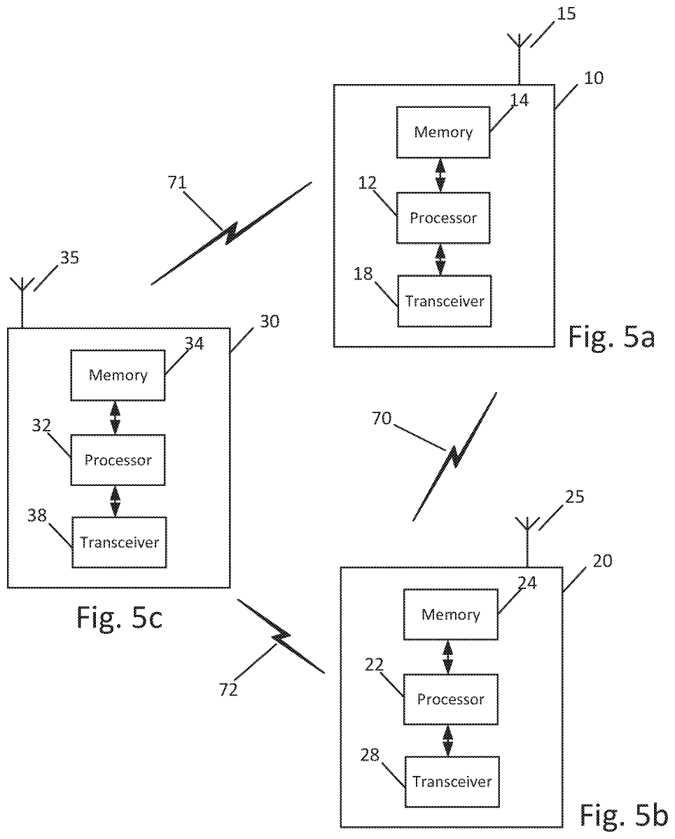

FIG. 5a illustrates an example of an apparatus 10 according to an embodiment. In an embodiment, apparatus 10 may be a node, host, or server in a communications network or serving such a network. For example, apparatus 10 may be or may include an AF, NMS, base station, a Node B, an evolved Node B (eNB), 5G Node B or access point, next generation Node B (NG-NB or gNB), CU of a gNB, WLAN access point, and/or other entity associated with a radio access network, such as 5G or NR. In one example, apparatus 10 may represent an AF as depicted in FIG. 2 or 3.

As illustrated in the example of FIG. 5a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or entity, such as an AF, or the like. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as the flow diagram illustrated in FIG. 4a. For instance, in some examples, apparatus 10 may correspond to or represent the AF depicted in FIG. 2 or 3. In certain embodiments, apparatus 10 may be configured to perform a procedure for identifying devices or endpoints connected via a 5GS.

In one embodiment, apparatus 10 may be controlled by memory 14 and processor 12 to receive a message comprising QoS requirements of one or more devices. For example, the QoS requirements may be stream requirements for the device(s), such as latency, periodicity, burst size, and/or jitter, etc. In an embodiment, the message may also include a MAC address and/or IP address of the device(s). In some embodiments, apparatus 10 may receive the message indicating the QoS requirements from the device(s), from a network server (e.g., CUC), or via registration of devices by the network owner. According to certain embodiments, the device(s) may be connected via a UE or via a wired network.

In an embodiment, apparatus 10 may be controlled by memory 14 and processor 12 to receive, from a 5GS, information indicating which devices are connected via the 5GS. For example, apparatus 10 may be controlled by memory 14 and processor 12 to receive, from the 5GS, MAC addresses and/or IP addresses of devices connected via the 5GS. Optionally, in an embodiment, apparatus 10 may be controlled by memory 14 and processor 12 to receive a UE ID (e.g., GPSI) associated with MAC addresses of devices connected via the 5GS. In some embodiments, apparatus 10 may be controlled by memory 14 and processor 12 to receive, from the 5GS, additional information associated with device connectivity via the 5GS, such as achievable delay or bandwidth for packets that require QoS.

According to some embodiments, in order to receive information indicating which devices are connected via the 5GS, apparatus 10 may be controlled by memory 14 and processor 12 to subscribe to exposure by the 5GS of MAC addresses, IP addresses, and/or UE-IDs (e.g., GPSI) associated with connected devices. In this embodiment, apparatus 10 may be controlled by memory 14 and processor 12 to receive, when a new MAC address is learned by the 5GS, a notification of the MAC address, IP address, and/or UE-ID (e.g., GPSI) associated with the newly learned connected device. In an embodiment, apparatus 10 may be controlled by memory 14 and processor 12 to receive a timestamp of when the MAC address was last seen. The subscription may be specific to a slice (S-NSSAI), DNN or other filter criteria.

In other embodiments, in order to receive information indicating which devices are connected via the 5GS, after receiving QoS requirements from a device, apparatus 10 may be controlled by memory 14 and processor 12 to send a query to the 5GS (NEF) with the MAC address or IP address of the device. In this embodiment, apparatus 10 may be controlled by memory 14 and processor 12 to receive, when the MAC address or IP address in the query matches a MAC address or IP address of one of the devices connected via the 5GS, an indication of the match, and optionally receive the corresponding UE ID (e.g., GPSI) for the requested MAC address.

According to an embodiment, apparatus 10 may be controlled by memory 14 and processor 12 to determine whether the device(s) for which QoS requirements have been received is connected via the 5GS by correlating the MAC address or IP address received from the 5GS with the MAC address or IP address received with the QoS requirements of the device(s). When it is determined that the device(s) are connected via the 5GS, then apparatus 10 may be controlled by memory 14 and processor 12 to request QoS, from the 5GS, for the device(s). In an embodiment, apparatus 10 may be controlled by memory 14 and processor 12 to use the MAC address and/or UE ID to request the QoS from the 5GS. According to an embodiment, apparatus 10 may be controlled by memory 14 and processor 12 to request for TSC and/or to provide TSCAI for the UE/PDU session that will carry the flow requested by the device(s). Further, in some embodiments, apparatus 10 may be controlled by memory 14 and processor 12 to use the information received from the 5GS associated with device connectivity, such as achievable delay or available bandwidth, to formulate the request for QoS. When it is determined that the device(s) are not connected (i.e., there is not a match between address(es) received from the 5GS and address(es) received with the QoS requirements of the device(s)), then apparatus 10 may be controlled by memory 14 and processor 12 to not request QoS from the 5GS.

FIG. 5b illustrates an example of an apparatus 20 according to another example embodiment. In example embodiments, apparatus 20 may be a node or server associated with a radio access network, such as a LTE network, 5G or NR or other radio systems which might benefit from an equivalent procedure. For example, apparatus 20 may be or may include a 5GS entity, such as a UPF, NEF, or SMF, base station, a Node B, an evolved Node B (eNB), 5G Node B or access point, next generation Node B (NG-NB or gNB), CU of a gNB, WLAN access point, and/or other entity associated with a radio access network, such as 5G or NR. In one example, apparatus 20 may represent a 5GS entity as depicted in FIG. 2 or 3. For instance, apparatus 20 may represent one or more of a UPF, NEF or SMF.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 5b.

In some example embodiments, apparatus 20 may include one or more processors, one or more computer-readable storage medium (for example, memory, storage, or the like), one or more radio access components (for example, a modem, a transceiver, or the like), and/or a user interface. In some example embodiments, apparatus 20 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 20 may include components or features not shown in FIG. 5b.

As illustrated in the example of FIG. 5b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5b, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an example embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink

For instance, in one example embodiment, transceiver 28 may be configured to modulate information on to a carrier waveform for transmission by the antenna(s) 25 and demodulate information received via the antenna(s) 25 for further processing by other elements of apparatus 20. In other example embodiments, transceiver 28 may be capable of transmitting and receiving signals or data directly. Additionally or alternatively, in some example embodiments, apparatus 10 may include an input and/or output device (I/O device). In certain examples, apparatus 20 may further include a user interface, such as a graphical user interface or touchscreen.

In an example embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR. For instance, in an example embodiment, link 70 may represent the Xn interface.

According to some example embodiments, processor 22 and memory 24 may be included in or may form a part of processing circuitry or control circuitry. In addition, in some example embodiments, transceiver 28 may be included in or may form a part of transceiving circuitry.

As discussed above, according to example embodiments, apparatus 20 may be a network node or entity, such as an entity in 5GS, a UPF, NEF and/or SMF, or the like. According to certain embodiments, apparatus 20 may be controlled by memory 14 and processor 12 to perform the functions associated with any of the embodiments described herein. For example, in some embodiments, apparatus 20 may be configured to perform one or more of the processes depicted in any of the flow charts or signaling diagrams described herein, such as the flow chart of FIG. 4b. For instance, in some examples, apparatus 20 may correspond to or represent the UPF, NEF, and/or SMF depicted in FIG. 2 or 3. In certain embodiments, apparatus 20 may be configured to perform a procedure for identifying devices or endpoints connected via the 5GS.

According to certain embodiments, apparatus 20 may be controlled by memory 24 and processor 22 to learn a MAC address of one or more device(s). For example, apparatus 20 may be controlled by memory 24 and processor 22 to learn the MAC address of the device(s) based on data (e.g., PDU) transmitted by the device(s). In an embodiment, apparatus 20 may be controlled by memory 24 and processor 22 to discover the IP address of the device(s), e.g., based on the learned MAC address. According to some embodiments, apparatus 20 may be controlled by memory 24 and processor 22 to provide information, to an AF, indicating which device(s) are connected via the 5GS. For example, in an embodiment, apparatus 20 may be controlled by memory 24 and processor 22 to provide information associated with device connectivity via the 5GS, such as achievable delay or bandwidth for packets that require QoS.

According to some embodiments, in order to provide the information indicating which devices are connected via the 5GS, apparatus 20 may be controlled by memory 24 and processor 22 to receive, from the AF, a request to subscribe to notification of MAC addresses learned for device(s). If the AF's request to subscribe is authorized, apparatus 20 may be controlled by memory 24 and processor 22 to provide, when a new MAC address is learned by the 5GS, a notification containing the learned MAC address, IP address, and/or UE-ID (eg: GPSI) associated with the newly learned connected device. In an embodiment, apparatus 20 may be controlled by memory 24 and processor 22 to provide a timestamp of when the MAC address was last seen. In a further embodiment, apparatus 20 may be controlled by memory 24 and processor 22 to provide a notification to the AF when the MAC address has not been seen by the apparatus 20 for some pre-configured time period. According to an embodiment, the subscription may be specific to a slice (S-NSSAI), DNN or other filter criteria.

In another embodiment, in order to provide the information indicating which devices are connected via the 5GS, apparatus 20 may be controlled by memory 24 and processor 22 to receive a query, from the AF, with one or more MAC addresses or IP addresses of one or more devices. In this embodiment, apparatus 20 may be controlled by memory 24 and processor 22 to determine whether the MAC address or IP address in the query matches a MAC address or IP address of one of the devices connected via the 5GS and, if so, to transmit an indication of the match to the AF, and optionally to provide the corresponding UE ID (e.g., GPSI) for the requested MAC address.

According to an embodiment, apparatus 20 may be controlled by memory 24 and processor 22 to receive a request for QoS, from the AF, for the device(s). In an embodiment, apparatus 20 may be controlled by memory 24 and processor 22 to receive the MAC address and/or UE ID with the request for QoS from the AF. According to an embodiment, apparatus 20 may be controlled by memory 24 and processor 22 to receive a request for TSC and/or to receive TSCAI for the UE/PDU session that will carry the flow requested by the device(s). In one embodiment, when resources are available, apparatus 20 may be controlled by memory 24 and processor 22 to provide the requested QoS for the device(s).

FIG. 5c illustrates an example of an apparatus 30 according to another example embodiment. In an example embodiment, apparatus 30 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device or NB-IoT device, a connected car, or the like. As one example, apparatus 30 may be implemented in, for instance, a wireless handheld device, a wireless plug-in accessory, or the like. In one embodiment, apparatus 30 may represent or include a device, IoT device, UE and/or bridge, as illustrated in the examples of FIG. 2 or 3.

In some example embodiments, apparatus 30 may include one or more processors, one or more computer-readable storage medium (for example, memory, storage, or the like), one or more radio access components (for example, a modem, a transceiver, or the like), and/or a user interface. In some example embodiments, apparatus 30 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 30 may include components or features not shown in FIG. 5c.

As illustrated in the example of FIG. 5c, apparatus 30 may include or be coupled to a processor 32 for processing information and executing instructions or operations. Processor 32 may be any type of general or specific purpose processor. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 32 is shown in FIG. 5c, multiple processors may be utilized according to other example embodiments. For example, it should be understood that, in certain example embodiments, apparatus 30 may include two or more processors that may form a multiprocessor system (e.g., in this case processor 32 may represent a multiprocessor) that may support multiprocessing. In certain example embodiments, the multiprocessor system may be tightly coupled or loosely coupled (e.g., to form a computer cluster).

Processor 32 may perform functions associated with the operation of apparatus 30 including, as some examples, precoding of antenna gain/phase parameters, encoding and decoding of individual bits forming a communication message, formatting of information, and overall control of the apparatus 30, including processes related to management of communication resources.

Apparatus 30 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 34 can be comprised of any combination of random access memory (RAM), read only memory (ROM), static storage such as a magnetic or optical disk, hard disk drive (HDD), or any other type of non-transitory machine or computer readable media. The instructions stored in memory 34 may include program instructions or computer program code that, when executed by processor 32, enable the apparatus 30 to perform tasks as described herein.

In an example embodiment, apparatus 30 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 32 and/or apparatus 30.

In some example embodiments, apparatus 30 may also include or be coupled to one or more antennas 35 for receiving a downlink signal and for transmitting via an uplink from apparatus 30. Apparatus 30 may further include a transceiver 38 configured to transmit and receive information. The transceiver 38 may also include a radio interface (e.g., a modem) coupled to the antenna 35. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink

For instance, transceiver 38 may be configured to modulate information on to a carrier waveform for transmission by the antenna(s) 35 and demodulate information received via the antenna(s) 35 for further processing by other elements of apparatus 30. In other example embodiments, transceiver 38 may be capable of transmitting and receiving signals or data directly. Additionally or alternatively, in some example embodiments, apparatus 30 may include an input and/or output device (I/O device). In certain example embodiments, apparatus 30 may further include a user interface, such as a graphical user interface or touchscreen.

In an example embodiment, memory 34 stores software modules that provide functionality when executed by processor 32. The modules may include, for example, an operating system that provides operating system functionality for apparatus 30. The memory may also store one or more functional modules, such as an application or program, to provide additional functionality for apparatus 30. The components of apparatus 30 may be implemented in hardware, or as any suitable combination of hardware and software. According to an example embodiment, apparatus 30 may optionally be configured to communicate with apparatus 10 via a wireless or wired communications link 71 and/or to communicate with apparatus 20 via a wireless or wired communications link 72, according to any radio access technology, such as NR.

According to some example embodiments, processor 32 and memory 34 may be included in or may form a part of processing circuitry or control circuitry. In addition, in some example embodiments, transceiver 38 may be included in or may form a part of transceiving circuitry.

As discussed above, according to some example embodiments, apparatus 30 may be a client, UE, mobile device, mobile station, ME, IoT device and/or NB-IoT device, for example. According to certain example embodiments, apparatus 30 may be controlled by memory 34 and processor 32 to perform the functions associated with example embodiments described herein. For instance, in some embodiments, apparatus 30 may be configured to perform one or more of the processes depicted in any of the diagrams or signaling flow diagrams described herein. As an example, apparatus 30 may correspond to one or more of the devices, UEs or bridges in FIG. 2 or 3.

In on embodiment, apparatus 30 may be controlled by memory 34 and processor 32 to transmit data, for example, via an Ethernet PDU session established by a UE with the network. According to an embodiment, apparatus 30 may be controlled by memory 34 and processor 32 to provide a request with its QoS requirements to an AF, a CUC, and/or a management plane server, or the like. In an embodiment, apparatus 30 may be controlled by memory 34 and processor 32 to identify itself in the request by its MAC address.

Furthermore, it should be noted that an apparatus, according to certain example embodiments, may include means or functions for performing any of the procedures described herein.

In view of the above, certain example embodiments provide several technological improvements, enhancements, and/or advantages over existing technological processes and constitute an improvement at least to the technological field of wireless network control and management. For example, certain embodiments provide a system and method identifying devices or endpoints and receiving information about their connectivity through a 5GS. For instance, some embodiments may address at least the problem where an AF has no knowledge of whether a device/endpoint is connected to a 5GS and, therefore, does not know if it should request QoS from the 5GS. Example embodiments are able to provide to the AF, e.g., via an exposure framework, the identity of wireless connected endpoints. This identification allows the AF to request appropriate QoS from the 5GS for the devices/endpoints as specified in the device requirements including for TSC services. As a result, example embodiments may at least improve throughput, latency, and/or processing speed of network nodes and/or UEs. Accordingly, the use of certain example embodiments results in improved functioning of communications networks and their nodes, such as base stations, eNBs, gNBs, and/or UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations required for implementing functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20 or apparatus 30), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1. A method, comprising:
receiving a message comprising quality of service (QoS) requirements of at least one device, and at least one of a medium access control (MAC) address or internet protocol (IP) address of the at least one device;
receiving, from a 5GS, information indicating which devices are connected via the 5GS;
determining that the at least one device for which QoS requirements have been received is connected via the 5GS using the information indicating which devices connected via the 5GS received from the 5GS; and
requesting QoS from the 5GS for the at least one device.

2. The method according to claim 1, wherein the QoS requirements comprise at least one of latency, periodicity, burst size, or jitter.

3. The method according to claim 1, wherein the message is received from the at least one device or from a network server.

4. The method according to claim 1, wherein the at least one device is connected to the 5GS via a user equipment (UE) or to the 5GS via a wired network connected to a user equipment (UE) or to a user plane function (UPF) of the 5GS.

5. The method according to claim 1, wherein the receiving information comprises receiving at least one of MAC addresses or IP addresses of devices connected via the 5GS.

6. The method according to claim 1, wherein the receiving information comprises receiving a user equipment identifier (UE ID) associated with MAC addresses of devices connected via the 5GS.

7. The method according to claim 6, wherein the method further comprises:
subscribing to exposure by the 5GS of at least one of MAC addresses, IP addresses, or UE ID associated with the devices connected via the 5GS; and
when a MAC address of a new device is learned by the 5GS, receiving a notification of the learned MAC address of the new device, IP address, or UE ID associated with the new device.

8. The method according to claim 1, wherein the receiving information comprises polling the 5GS for updates in fixed intervals for the information indicating which devices are connected via the 5GS.

9. The method according to claim 7, further comprising receiving a timestamp indicating when the MAC address of the new device was last seen.

10. The method according to claim 1, wherein the determining comprises:
after receiving the QoS requirements for the at least one device, sending a query to the 5GS with the least one of the MAC address or IP address of the at least one device;
when the at least one of the MAC address or IP address in the query matches a MAC address or IP address of one of the devices connected via the 5GS, receiving an indication of the match.

11. The method according to claim 1, wherein the requesting comprises using at least one of the MAC address or UE ID to request the QoS from the 5GS.

12. The method according to claim 1, wherein the requesting comprises at least one of: requesting QoS for time sensitive communication (TSC); or providing TSC assistance information (TSCAI) for the user equipment (UE)/protocol data unit (PDU) session that will carry a flow requested by the at least one device.

13. A method, comprising:
learning a medium access control (MAC) address of at least one device connected to a 5GS;
providing information, to an application function (AF), indicating which devices are connected via the 5GS; and
receiving a request for quality of service (QoS), from the AF, for one or more of the devices connected via the 5GS.

14. The method according to claim 13, wherein the learning comprises learning the MAC address of the at least one device connected to a 5GS based on data transmitted by the at least one device.

15. The method according to claim 13, wherein the learning comprises discovering an internet protocol (IP) address of the at least one device.

16. The method according to claim 13, wherein, the providing information indicating which devices are connected via the 5GS comprises:
receiving, from the AF, a request for notifications of MAC addresses learned for devices;
when a new MAC address is learned for a device, providing a notification containing at least one of the learned MAC address, IP address, or identifier of a user equipment associated with the learned MAC address for the device.

17. The method according to claim 16, further comprising providing the notification to the AF when the MAC address has not been seen by the 5GS for some pre-configured time period.

18. The method according to claim 13, wherein providing the information indicating which devices are connected via the 5GS comprises:
receiving a query, from the AF, with one or more MAC addresses or IP addresses of one or more devices;
determining whether the MAC address or IP address in the query matches a MAC address or IP address of one of the devices connected via the 5GS; and
when there is a match, transmitting an indication of the match to the AF.

19. (canceled)

20. The method according to claim 13, wherein the receiving comprises at least one of: receiving a request for TSC and/or receiving a time sensitive communication assistance information (TSCAI) for the UE/PDU session that will carry a flow requested by the devices.

21. (canceled)

22. An apparatus, comprising:
at least one processor; and
at least one memory comprising computer program code,
the at least one memory and computer program code configured, with the at least one processor, to cause the apparatus at least to
receiving a message comprising quality of service (QoS) requirements of at least one device, and at least one of a medium access control (MAC) address or internet protocol (IP) address of the at least one device:
receiving, from a 5GS, information indicating which devices are connected via the 5GS;
determining that the at least one device for which QoS requirements have been received is connected via the 5GS using the information indicating which devices connected via the 5GS received from the 5GS; and
requesting QoS from the 5GS for the at least one device.

23. (canceled)

24. (canceled)

25. (canceled)
